(19) United States
(12) Patent Application Publication
(10) Pub. No.: US 2025/0142668 A1
(43) Pub. Date: May 1, 2025

(54) EXTENDED REALITY DEVICE, BASE STATION, AND DISCONTINUOUS RECEPTION CONFIGURATION ALLOCATING METHOD FOR EXTENDED REALITY DEVICE

(71) Applicant: INSTITUTE FOR INFORMATION INDUSTRY, TAIPEI (TW)

(72) Inventor: Jhih Min YANG, TAIPEI (TW)

(21) Appl. No.: 18/519,065

(22) Filed: Nov. 26, 2023

(30) Foreign Application Priority Data
Nov. 1, 2023 (TW) 112142101

(51) Int. Cl. H04W 76/28

(52) U.S. Cl. CPC H04W 76/28

(57) ABSTRACT

An extended reality (XR) device includes a transceiver and a processor. The transceiver is configured to perform wireless signal transmissions and receptions. The processor is configured to perform the following operations: receiving a connected-mode discontinuous reception (C-DRX) configuration message from a base station, in which the C-DRX configuration message corresponds to an XR frame rate mode and corresponds to C-DRX configuration sequences, the XR frame rate mode is in a unit of millisecond, and the XR frame rate mode is a non-integer frame rate mode; and selecting one of the C-DRX configuration sequences as a selected C-DRX configuration sequence of the XR device.

### RELATED APPLICATIONS

This application claims priority to Taiwan Application Serial Number 112142101, filed Nov. 1, 2023, which are herein incorporated by reference.

### BACKGROUND

### Technical Field

The present disclosure relates to allocating discontinuous reception (DRX) configuration of extended reality (XR), and more particularly to an XR device, a base station, and a DRX configuration allocating method for an XR device.

### Description of Related Art

5G New Radio (NR) is a recently developed radio access technology that supports high throughput, low latency, and high-capacity communications. In addition, extended reality (XR) applications, such as virtual reality (VR), augmented reality (AR), mixed reality (MR) and/or the like, have been progressively developed in recent years, and have been being adopted in a variety of real-time applications, such as industrial, medical, and educational applications.

### SUMMARY

One aspect of the present disclosure directs to an XR device which includes a transceiver and a processor. The transceiver is configured to perform wireless signal transmissions and receptions. The processor is coupled to the transceiver, and is configured to perform the following operations: receiving a connected-mode discontinuous reception (C-DRX) configuration message from a base station via the transceiver, in which the C-DRX configuration message corresponds to an XR frame rate mode and corresponds to C-DRX configuration sequences, the XR frame rate mode is in a unit of millisecond, and the XR frame rate mode is a non-integer frame rate mode; and selecting one of the C-DRX configuration sequences as a selected C-DRX configuration sequence of the XR device according to performance information of the XR device.

Another aspect of the present disclosure directs to a base station which includes a transceiver and a processor. The transceiver is configured to perform wireless signal transmissions and receptions. The processor is coupled to the transceiver, and is configured to perform the following operations: allocating C-DRX configuration sequences for XR device according to an XR frame rate mode, in which the XR frame rate mode is in a unit of millisecond, and the XR frame rate mode is a non-integer frame rate mode; and transmitting a C-DRX configuration message to the XR device via the transceiver, in which the C-DRX configuration message corresponds to the XR frame rate mode and corresponds to the C-DRX configuration sequences.

Yet another aspect of the present disclosure directs to a DRX configuration allocating method for an XR device including: receiving a C-DRX configuration message from a base station via the transceiver, in which the C-DRX configuration message corresponds to an XR frame rate mode and corresponds to C-DRX configuration sequences, the XR frame rate mode is in a unit of millisecond, and the XR frame rate mode is a non-integer frame rate mode; and selecting one of the C-DRX configuration sequences as a selected C-DRX configuration sequence of the XR device according to performance information of the XR device.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is an example of performing XR packet receptions at an XR frame rate of 60 fps.

FIGS. 3A and 3B are various examples of XR packet receptions performed in a configuration in which a XR frame rate is 60 fps and a base station transmits XR packets in a period of non-integer milliseconds.

FIG. 4 is a schematic block diagram of an XR device in accordance with some embodiments of the present disclosure.

FIG. 5 is a flowchart of a DRX configuration allocating method in accordance with some embodiments of the present disclosure.

FIG. 6 is a schematic block diagram of a base station in accordance with some embodiments of the present disclosure.

FIG. 7 is a flowchart of a DRX configuration allocating method in accordance with some embodiments of the present disclosure.

FIG. 8 is a flowchart of a DRX configuration allocating method in accordance with some embodiments of the present disclosure.

FIG. 9 is a flowchart of a DRX configuration allocating method in accordance with some embodiments of the present disclosure.

### DETAILED DESCRIPTION

The detailed explanation of the present disclosure is described as following. The described preferred embodiments are presented for purposes of illustrations and description, and they are not intended to limit the scope of the present disclosure.

Terms used herein are only used to describe the specific embodiments, which are not used to limit the claims appended herewith. Unless limited otherwise, the term “a,” “an,” “one” or “the” of the single form may also represent the plural form.

It will be understood that, although the terms “first” and “second” may be used herein to describe various elements, these elements should not be limited by these terms. These terms are only used to distinguish one element from another. In addition, the operative term “determine” or “acquire” used herein may be replaced with another operative term “generate”, “calculate” or “compute”.

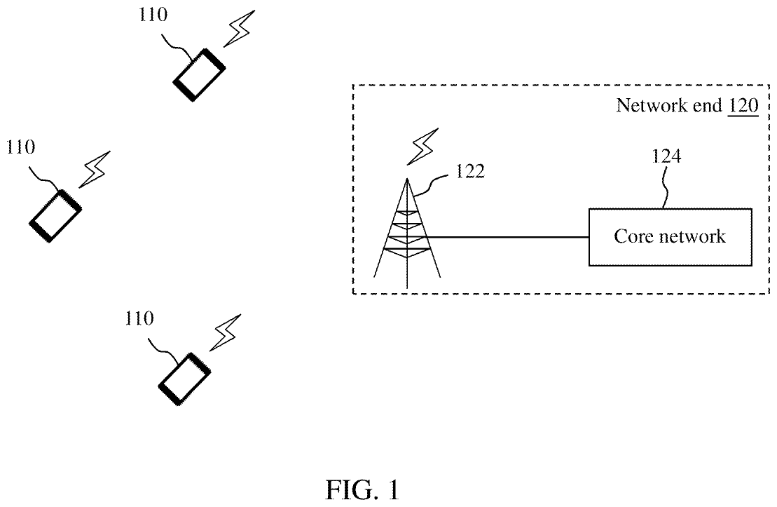

FIG. 1 is a schematic diagram of a wireless communication system 100 in accordance with some embodiments of the present disclosure. The wireless communication system 100 may be, for example, a 5G NR communication system, a Beyond 5G (B5G) communication system, a sixth generation (6G), and/or another similar wireless communication system (e.g., evolution of any of the above systems). In the wireless communication system 100, user equipments (UEs) 110 are connected to a network end 120 via a radio access network (RAN). The UEs 110 may be smartphones, tablets, VR head mounted devices, AR/MR glasses, or other devices that have XR functions and can be communicatively connected to the network end 120. In order to avoid unnecessary power consumption, the radio resource control (RRC) modes of the UEs 110 are divided into an idle mode, an inactive mode and an connected mode, and a discontinuous reception (DRX) mechanism which defines a packet receiving period and a sleep period in a DRX configuration is adopted in the connected mode. In XR applications, the UEs 110 adopt a connected mode discontinuous reception (C-DRX) mechanism for XR packet receptions in the connected mode.

The network end 120 includes a base station 122 and a core network 124. The base station 122 is configured to provide an interface for the UEs 110 to access the RAN. The core network 124 is configured to provide network services for each user equipment 110, and has various types of core network functions including, for example, an accessible and mobility function (AMF), an authentication server function (AUSF), a session management function (SMF), a unified data management (UDM), a policy and control function (PCF), a network repository function (NRF), a data network (DN) and/or another core network function. Each UE 110 is communicatively connected with the base station 122 via a wireless interface. In a case of 5G NR system, the base station 122 is also referred to as a Next Generation NodeB (gNB), an Evolved Universal Terrestrial Radio Access Network (E-UTRAN) Evolved NodeB (eNB), or a next-generation evolved base station (ng-eNB), the core network 124 is also referred to as a 5G Core (5GC) network or a 4G Evolved Packet Core (EPC) network that supports 5G functions, and the RAN may be referred to as a Next-Generation RAN (NG-RAN) or an evolved universal terrestrial wireless access network that supporting 5G functions.

In the current wireless communication system specifications (e.g., the 3GPP specifications), the frames per second (FPS) of the XR frame rates adopted for XR traffics includes 15, 30, 45, 60, 72, 90, and 120. The XR frame rates may be configured by the base station 122 according to, for example, the maximum downlink rate, the image resolution, and/or another factor (e.g., channel and software/hardware conditions) of the UE 110. However, the XR frame rate modes corresponding to these XR frame rates (i.e., the inverses of the XR frame rates) are all non-integer frame rate mode, e.g., the XR frame rate mode corresponding to the FPS of 60 (i.e., 60 fps) is 50/3 millisecond (ms), resulting in difficult for aligning with radio subframes in downlink packet receptions.

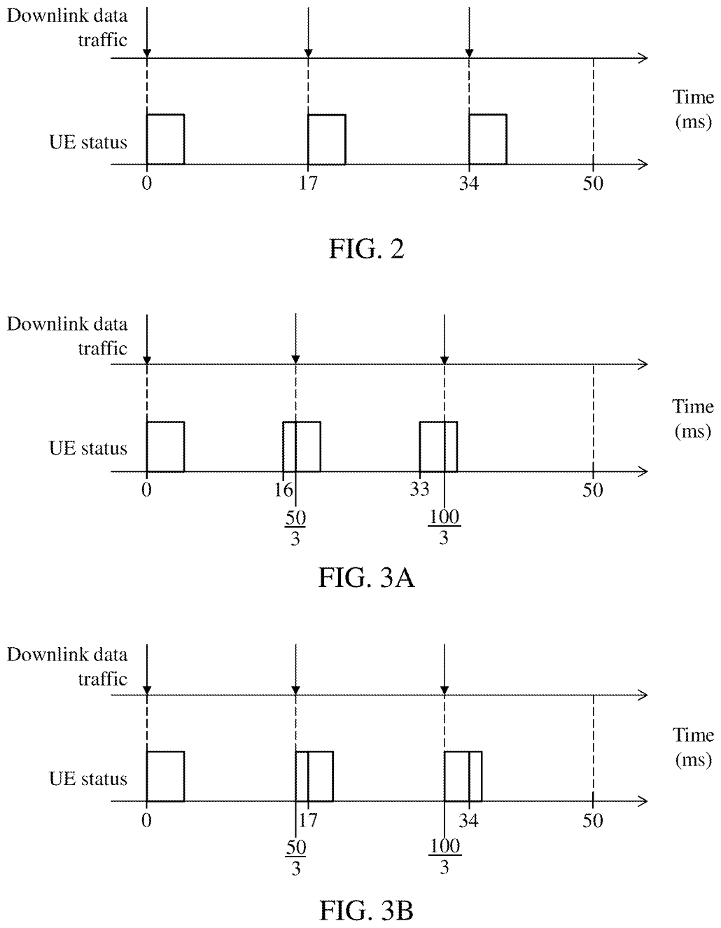

FIG. 2 is an example of performing XR packet receptions at an XR frame rate of 60 fps. As shown in FIG. 2, according to the current wireless communication system specifications, the base station 122 must send XR packets at 0 ms, 17 ms, and 34 ms in each 50 ms duration, and correspondingly the UE 110 must enter the wake-up state in the onDuration periods respectively starting at 0 ms, 17 ms, and 34 ms to receive XR packets. The frequency of receiving XR packets by the UE 110 (receiving XR packets every 17 ms) does not match the refresh rate of the UE 110 (the screen refreshed every 50/3 ms), additional process (e.g., timing control) is required on the XR packets.

If the base station 122 can transmit XR packets in a period of non-integer milliseconds (i.e., transmit XR packets at time points of non-integer milliseconds), the problem of mismatch between the frequency of receiving XR packets and the refresh rate of the UE 110 can be solved. However, according to the current wireless communication system specifications, the DRX configuration allocated to the UE 110 by the base station 122 can be only an integer (in a unit of millisecond), and thus two different DRX configurations are required. Moreover, the UE 110 can receive XR packets only at time points of integer milliseconds, which does not match the time points of non-integer milliseconds at which the base station 122 transmits XR packets, resulting in occurrence of different degrees of unnecessary delay and/or unnecessary power consumption.

FIG. 3A is an example of XR packet receptions performed in a configuration in which the XR frame rate is 60 fps and the base station 122 transmits XR packets in a period of non-integer milliseconds. As shown in FIG. 3A, the base station 122 transmits XR packets at 0 ms, 50/3 ms, and 100/3 ms in each 50-ms time length, and correspondingly the UE 110 enters the wake-up state in the onDuration periods respectively starting at 0 ms, 16 ms, and 33 ms according to the C-DRX configuration sequence [16, 17, 17] (including DRX configurations of 16 and 17 in milliseconds) configured by the base station 122. In FIG. 3A, the times points at which the UE 110 enters the wake-up state to receive XR packets for the second and third times are 16 ms and 33 ms, respectively, which are respectively earlier than the times points at which the base station 122 transmits XR packets for the second and third times (50/3 ms and 100/3 ms, respectively), and thus unnecessary power consumptions are generated in the periods from 16 ms to 50/3 ms and from 33 ms to 100/3 ms.

FIG. 3B is another example of XR packet receptions performed in a configuration in which the XR frame rate is 60 fps and the base station 122 transmits XR packets in a period of non-integer milliseconds. As shown in FIG. 3B, the base station 122 transmits XR packets at 0 ms, 50/3 ms, and 100/3 ms in each 50-ms time length, and correspondingly the UE 110 enters the wake-up state in the onDuration periods respectively starting at 0 ms, 17 ms, and 34 ms according to the C-DRX configuration sequence [17, 17, 16] configured by the base station 122. However, in FIG. 3B, the time points at which the UE 110 enters the wake-up state to receive XR packets for the second and third times are 17 ms and 34 ms, respectively, which are respectively later than the time points at which the base station 122 transmits XR packets for the second and third times (50/3 ms and 100/3 ms, respectively), thus unnecessary delays of 1/3 ms and 2/3 ms are respectively generated.

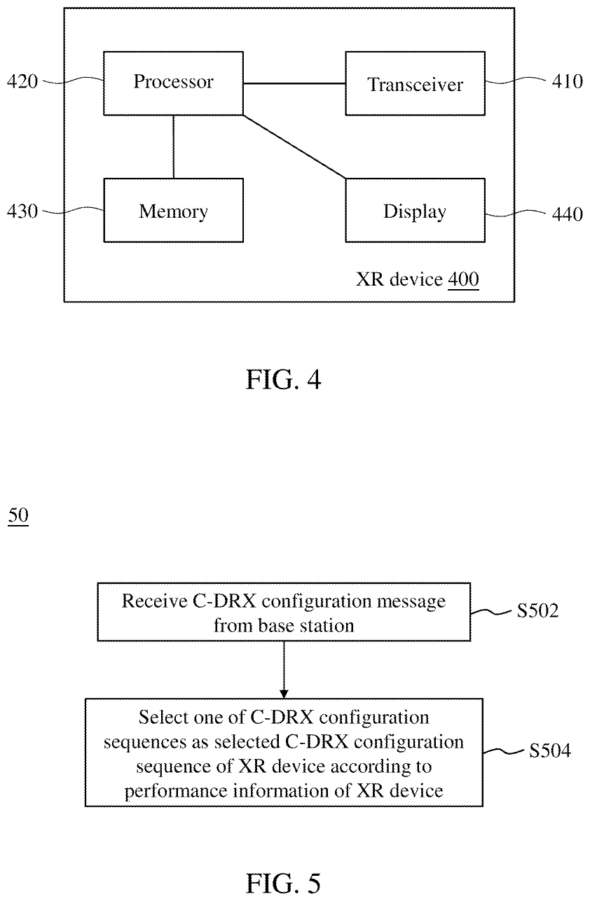

FIG. 4 is a schematic block diagram of an XR device 400 in accordance with some embodiments of the present disclosure. The XR device 400 may access a network end via a RAN. For example, the XR device 400 may be any UE 110 in FIG. 1. In addition, the XR device 400 may support various types of XR applications, including VR, AR, MR and/or another technology. The XR device 400 includes a transceiver 410, a processor 420, a memory 430, and a display 440.

The transceiver 410 may include an antenna, a radio frequency (RF) circuit, and a baseband circuit, which are used to perform wireless communicates with other entities (e.g., base stations in a network end) and perform wireless signal transmissions and receptions based on the operating results of the processor 420. For example, the transceiver 410 may be configured to receive RF signals, demodulate RF signals into baseband signals, decode baseband signals into bit data, and send bit data to the processor 420 for data processing, and/or encode bit data received from the processor 420 to into baseband signals, modulate baseband signal into RF signals, and transmit RF signals.

The processor 420 is coupled to the transceiver 410 and is configured to process received bit data, execute the functions of the XR device 400 accordingly, and/or generate bit data according to the functions in the XR device 400. The processor 420 may be, for example, a conventional processor, a central processor unit (CPU), a graphic processor unit (GPU), a digital signal processor (DSP), a microprocessor, an application-specific integrated circuit (ASIC), a field programmable gate array (FPGA), or a combination thereof, but is not limited thereto.

The memory 430 is coupled to the processor 420 and may be any data storage device readable and executable by the processor 420. The memory 430 may be, for example, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid-state drive, a flash, or another data storage device suitable for storing program codes, but is not limited thereto.

The display 440 is coupled to the processor 420 and may display images according to the processing result of the processor 420. The display 440 may be, for example, a liquid crystal display (LCD), an organic light-emitting diode (OLED), a micro-LED display, an electroluminescent (EL) display, an electronic paper display, or another suitable display.

FIG. 5 is a flowchart of a DRX configuration allocating method 50 in accordance with some embodiments of the present disclosure. The DRX configuration allocating method 50 is applicable to a terminal device with XR functions and in a wireless communication system, such as any UE 110 in the wireless communication system 100 in FIG. 1, the XR device 400 in FIG. 4, or another XR device with wireless communication functions. For example, if the DRX configuration allocating method 50 is applied to the XR device 400, it may be compiled into a computer program, and may be stored in the memory 430 and executed by the processor 420, in which message transmissions and/or receptions may be achieved by controlling the transceiver 410 to perform wireless signal transmissions and/or receptions by the processor 420.

The descriptions of the DRX configuration allocating method 50 are as following. First, Operation S502 is performed to receive a C-DRX configuration message from a base station. The C-DRX configuration message may correspond to the same XR frame rate mode and correspond to (e.g., include) plural C-DRX configuration sequences, in which the XR frame rate mode is in a unit of millisecond, and the XR frame rate mode is a non-integer frame rate mode.

In some embodiments, the C-DRX configuration sequences includes at least one non-decreasing sequence and at least one non-increasing sequence, in which each non-decreasing sequence corresponds to zero unnecessary delay, and each non-increasing sequence corresponds to zero unnecessary power consumption. In some examples, the maximum DRX configuration and the minimum DRX configuration in the C-DRX configuration sequences differ by 1 ms. In addition, each C-DRX configuration sequence may include two different DRX configurations, and the number of DRX configurations in each C-DRX configuration sequence is a minimal positive integer that multiplies the XR frame rate mode to become an integer. For example, if the FPS is 60 fps (corresponding to the XR frame rate mode of 50/3 ms), the number of DRX configurations in each C-DRX configuration sequence is 3; if the FPS is 90 fps (corresponding to the XR frame rate mode of 100/9 ms), the number of DRX configurations in each C-DRX configuration sequence is 9.

Then, Operation S504 is performed to select one of the C-DRX configuration sequences as a selected C-DRX configuration sequence of the XR device according to performance information of the XR device. The performance information includes information such as an amount of power consumption and/or an amount of delay, e.g., the remaining battery capacity of the XR device. For example, if the performance information of the XR device indicates that delay minimization is preferred, a C-DRX configuration sequence with a lower unnecessary delay is selected from these C-DRX configuration sequences as a selected C-DRX configuration sequence of the XR device for XR packet receptions; if the performance information of the XR device indicates that power consumption minimization is preferred, a C-DRX configuration sequence with a lower unnecessary power consumption is selected from these C-DRX configuration sequences as a selected C-DRX configuration sequence of the XR device for XR packet receptions.

In some embodiments, the DRX configuration allocating method 50 further includes transmitting a response message corresponding to the selected C-DRX configuration sequence to the base station, to notify the base station that the XR device has selected a selected C-DRX configuration sequence for XR packet receptions.

Taking 60 fps as an example, the C-DRX configuration message may correspond to three C-DRX configuration sequences, and the unnecessary power consumptions and the unnecessary delays corresponding to these C-DRX configuration sequences are shown in Table 1.

TABLE 1

| | Unnecessary power | Unnecessary |
|---|---|---|
| C-DRX configuration sequence | consumption | delay |
| [17, 17, 16] | 0 | 2% |
| [17, 16, 17] | 0.67% | 0.67% |
| [16, 17, 17] | 2% | 0 |

As can be seen from Table 1, the C-DRX configuration sequence [17, 17, 16] is a non-increasing sequence, and the unnecessary power consumption and the unnecessary delay corresponding thereto are respectively the minimal and the maximal; the C-DRX configuration sequence [16, 17, 17] is a non-decreasing sequence, and the unnecessary power consumption and the unnecessary delay corresponding thereto are respectively the maximal and the minimal; the unnecessary power consumption and the unnecessary delay corresponding to the C-DRX configuration sequence [16, 17, 17] are between the C-DRX configuration sequences [17, 17, 16] and [16, 17, 17]. The more backward the position of the DRX configuration 16 in the C-DRX configuration sequence, the lower the unnecessary power consumption and the higher the unnecessary delay.

Taking 90 fps as another example, the C-DRX configuration message may correspond to 9 C-DRX configuration sequences, and the unnecessary power consumptions and the unnecessary delays corresponding to these C-DRX configuration sequences are shown in Table 2.

TABLE 2

| | Unnecessary power | Unnecessary |
|---|---|---|
| C-DRX configuration sequence | consumption | delay |
| [12, 11, 11, 11, 11, 11, 11, 11, 11] | 0 | 4% |
| [11, 12, 11, 11, 11, 11, 11, 11, 11] | 0.11% | 3.15% |
| [11, 11, 12, 11, 11, 11, 11, 11, 11] | 0.33% | 2.37% |
| [11, 11, 11, 12, 11, 11, 11, 11, 11] | 0.66% | 1.7% |
| [11, 11, 11, 11, 12, 11, 11, 11, 11] | 1.1% | 1.14% |
| [11, 11, 11, 11, 11, 12, 11, 11, 11] | 1.65% | 0.69% |
| [11, 11, 11, 11, 11, 11, 12, 11, 11] | 2.31% | 0.35% |
| [11, 11, 11, 11, 11, 11, 11, 12, 11] | 3.08% | 0.12% |
| [11, 11, 11, 11, 11, 11, 11, 11, 12] | 4% | 0 |

As can be seen from Table 2, the C-DRX configuration sequence [12, 11, 11, 11, 11, 11, 11, 11, 11] is a non-increasing sequence, and the unnecessary power consumption and the unnecessary delay corresponding thereto are respectively the minimal and the maximal; the C-DRX configuration sequence [11, 11, 11, 11, 11, 11, 11, 11, 12] is a non-decreasing sequence, and the unnecessary power consumption and the unnecessary delay corresponding thereto are respectively the minimal and the maximal; the unnecessary power consumption and the unnecessary delay corresponding to each of the other C-DRX configuration sequences are between the C-DRX configuration sequences more backward the position of the DRX configuration 12 in the C-DRX configuration sequence, the higher the unnecessary power consumption and the lower the unnecessary delay.

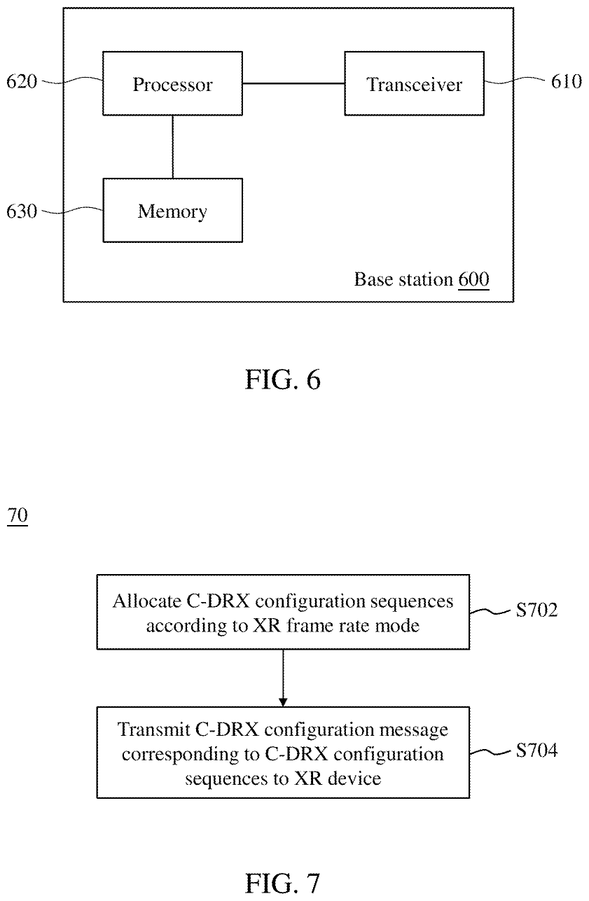

FIG. 6 is a schematic block diagram of a base station 600 in accordance with some embodiments of the present disclosure. The base station 600 may be configured to provide an interface for an XR device with wireless communication functions to connect a network end via a RAN. For example, the base station 600 may be the base station 122 in FIG. 1. The base station 600 includes a transceiver 610, a processor 620, and a memory 630, and the functions of the transceiver 610, the processor 620, and the memory 630 are respectively similar to the transceiver 410, the processor 420, and the memory 430 in FIG. 4, and thus the details thereof may be referred to the descriptions about the transceiver 410, the processor 420, and the memory 430 in the preceding paragraphs and is not repeated herein.

FIG. 7 is a flowchart of a DRX configuration allocating method 70 in accordance with some embodiments of the present disclosure. The DRX configuration allocating method 70 is applicable to a terminal device with XR functions in a wireless communication network, such as the base station 122 of the wireless communication system 100 in FIG. 1, the base station 600 in FIG. 6, or another XR device with wireless communication functions. For example, if the DRX configuration allocating method 70 is applied to the base station 600, it may be compiled into a computer program, and may be stored in the memory 630 and executed by the processor 620, in which message transmissions and/or receptions may be achieved by controlling the transceiver 610 to perform wireless signal transmissions and/or receptions by the processor 620.

The descriptions of the DRX configuration allocating method 70 are as following. First, Operation S702 is performed to allocate C-DRX configuration sequences according to an XR frame rate mode. The XR frame rate mode is in a unit of millisecond, and the XR frame rate mode is a non-integer frame rate mode. Then, Operation S704 is performed to transmit a C-DRX configuration message to the XR device. The C-DRX configuration message corresponds to the XR frame rate mode and corresponds to the C-DRX configuration sequences. The details of the C-DRX configuration message, the C-DRX configuration sequences, and the XR frame rate mode may be referred to the descriptions of the DRX configuration allocating method 50 and is not repeated herein.

In some embodiments, the C-DRX configuration sequences may be converted into DRX-adjustable configurations and indices, and the C-DRX configuration sequences corresponding to the C-DRX configuration message may be represented by the indices for facilitating the transmissions between the base station and the XR device. The DRX-adjustable configurations are greater than or equal to 0 and less than 1. If the FPS is 15 fps, 60 fps, or 72 fps, the DRX-adjustable configurations comply with Equation (1):

$$( drx - adjustable cycle ) modulo [ drx - shortcycle - floor ( drx - shortcycle ) ] = 0 , \qquad ( 3 )$$

where “drx-adjustable cycle” represents DRX-adjustable configuration, “drx-shortcycle” represents XR frame rate mode, modulo(⋅) represents a modulo operation, and ceiling(⋅) represents a ceiling function, and the relation between the DRX-adjustable configurations and the indices is shown in Equation (2):

$$\begin{matrix}drx - adjustable cycle ( index ) [ ceiling ( drx - shortcycle ) - drx - shortcycle ] \\ = drx - adjustable cycle ,\end{matrix} \qquad ( 2 )$$

where “drx-adjustable cycle(index)” are indices. IF the FPS is 30 fps, 45 fps, 90 fps, or 120 fps, the DRX-adjustable configurations comply with Equation (3):

$$\begin{matrix}drx - adjustable cycle ( index ) [ drx - shortcycle - floor ( drx - shortcycle ) ] \\ = drx - adjustable cycle .\end{matrix} \qquad ( 4 )$$

where floor(⋅) represents a floor operation, and the relation between the DRX-adjustable configurations and the indices is shown in Equation (4):

$$( drx - adjustable cycle ) modulo [ ceiling ( drx - shortcycle ) - drx - shortcycle ] = 0 , \qquad ( 1 )$$

For example, in the FPS of 60 fps (corresponding to the XR frame rate mode of 50/3 ms), the DRX-adjustable configurations include 0, 1/3, 2/3, and as shown in Table 3, the DRX-adjustable configurations of 0, 1/3, 2/3 respectively corresponding to the indices of 0, 1, and 2, and the C-DRX configuration sequences corresponding thereto are respectively [17, 17, 16], [17, 16, 17], [16, 17, 17]; in the FPS of 90 fps (corresponding to the XR frame rate mode of 100/9 ms), the DRX-adjustable configurations include 0, 1/9, 2/9, 3/9, 4/9, 5/9, 6/9, 7/9, 8/9, and as shown in Table 4, the index and the C-DRX configuration sequence corresponding to the DRX-adjustable configuration of 0 are respectively 0 and [12, 11, 11, 11, 11, 11, 11, 11, 11], the index and the C-DRX configuration sequence corresponding to the DRX-adjustable configuration of 1/9 are respectively 1 and [11, 12, 11, 11, 11, 11, 11, 11, 11], the index and the C-DRX configuration sequence corresponding to the DRX-adjustable configuration of 2/9 are respectively 2 and [11, 11, 12, 11, 11, 11, 11, 11, 11], and the like.

TABLE 3

| | DRX-adjustable | |
|---|---|---|
| C-DRX configuration sequence | configuration | Index |
| [17, 17, 16] | 0 | 0 |
| [17, 16, 17] | 1/3 | 1 |
| [16, 17, 17] | 2/3 | 2 |

TABLE 4

| | DRX-adjustable | |
|---|---|---|
| C-DRX configuration sequence | configuration | Index |
| [12, 11, 11, 11, 11, 11, 11, 11, 11] | 0 | 0 |
| [11, 12, 11, 11, 11, 11, 11, 11, 11] | 1/9 | 1 |
| [11, 11, 12, 11, 11, 11, 11, 11, 11] | 2/9 | 2 |
| [11, 11, 11, 12, 11, 11, 11, 11, 11] | 3/9 | 3 |
| [11, 11, 11, 11, 12, 11, 11, 11, 11] | 4/9 | 4 |
| [11, 11, 11, 11, 11, 12, 11, 11, 11] | 5/9 | 5 |
| [11, 11, 11, 11, 11, 11, 12, 11, 11] | 6/9 | 6 |
| [11, 11, 11, 11, 11, 11, 11, 12, 11] | 7/9 | 7 |
| [11, 11, 11, 11, 11, 11, 11, 11, 12] | 8/9 | 8 |

After receiving the C-DRX configuration message, the XR device may select one of the DRX-adjustable configurations for XR packet receptions. The XR device may calculate the time points to enter the wake-up state for XR packet receptions according to Equation (5):

floor{[(SFN×10)+subframe number+(drx-adjustable cycle)]modulo (drx-ShortCycle)}=floor{(drx-StartOffset) modulo (drx-ShortCycle)}, (5)

where “SFN” is a system frame number which is an integer in a range from 0 or 1023, “subframe number” is the number of subframes, i.e., the time point for starting each DRX configuration, which is an integer in a range from 0 to 9, and “drx-StartOffset” is a DRX offset parameter.

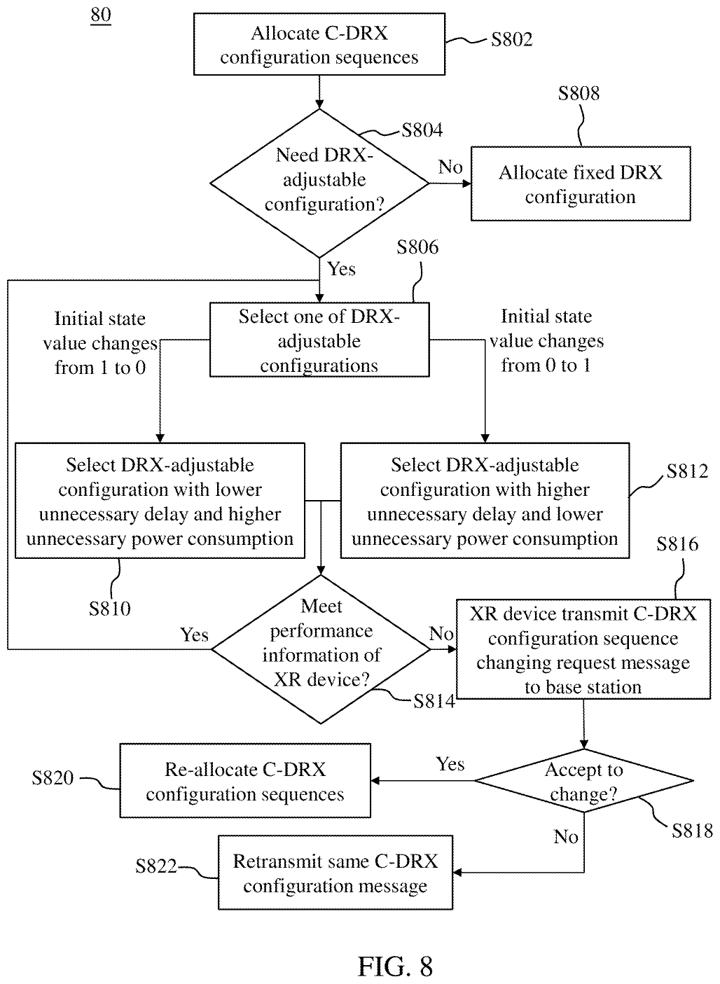

FIG. 8 is a flowchart of a DRX configuration allocating method 80 in accordance with some embodiments of the present disclosure. The DRX configuration allocating method 80 is applicable in the wireless communication system 100 in FIG. 1, in which some operations are performed at the base station 122, while the other operations are performed at any UE 110 (i.e., an XR device).

In Operation S802, the base station allocates C-DRX configuration sequences for the XR device according to an XR frame rate mode and transmits a C-DRX configuration message to the XR device via the transceiver. The C-DRX configuration message corresponds to the XR frame rate mode and corresponds to the C-DRX configuration sequences.

In Operation S804, the XR device determines whether a DRX-adjustable configuration is needed (e.g., by determining whether there is a DRX-adjustable configuration in the C-DRX configuration message). If “yes”, Operation S806 is performed, in which the XR device selects one of the DRX-adjustable configurations according to the performance information thereof. Otherwise, Operation S808 is performed, in which the base station allocates a fixed CDX configuration for the XR device.

The power status of the XR device may be represented by an initial state value. The initial state value of 0 may represent that the remaining battery capacity of the XR device is sufficient (e.g., the remaining battery capacity is greater than 30%), while the initial state value of 1 may represent that the remaining battery capacity of the XR device is insufficient (e.g., the remaining battery capacity is below than 30%). In Operation S806, if the initial state value changes from 1 to 0 (indicating that the main requirement is low delay), Operation S810 is then proceeded to select one of the DRX-adjustable configurations with a lower unnecessary delay and a higher unnecessary power consumption (i.e., select a DRX-adjustable configuration with a lower unnecessary delay and a higher unnecessary power consumption); if the initial state value changes from 0 to 1 (indicating that the main requirement is low power consumption), Operation S812 is then proceeded to select one of the DRX-adjustable configuration with a higher unnecessary delay and a lower unnecessary power consumption (i.e., select a DRX-adjustable configuration with a higher unnecessary delay and a lower unnecessary power consumption).

For example, if the FPS is 60 fps, it can be selected by referencing Tables 1 and 3 that, the DRX-adjustable configuration with a lower unnecessary delay and a higher unnecessary power consumption is 2/3 (the corresponding index is 2), while the DRX-adjustable configuration with a higher unnecessary delay and a lower unnecessary power consumption is 0 (the corresponding index is 0); if the FPS is 90 fps, it can be selected by referencing Tables 2 and 4 that, the DRX-adjustable configurations with lower unnecessary delays and higher unnecessary power consumptions include 8/9, 7/9, 6/9 (the corresponding indices are 6, 7, and 8), while the DRX-adjustable configurations with higher unnecessary delays and lower unnecessary power consumptions include 0, 1/9, 2/9 (the corresponding indices are 0, 1, and 2).

After Operation S810/S812 is performed, Operation S814 is proceeded, in which the XR device determines whether the C-DRX configuration sequence corresponding to the DRX-adjustable configuration meets the performance information of the XR device. If the determination result is “yes” (i.e., meet the performance information of the XR device, such as the unnecessary delay is less than an amount of delay and the unnecessary power consumption is less than an amount of power consumption), the XR device uses the C-DRX configuration sequence as a selected C-DRX configuration sequence for XR packet receptions, and then Operation S806 is returned. On the contrary, if the determination result is “no”, which represents that neither of the DRX-adjustable configurations in the C-DRX configuration message meet the performance information of the XR device (i.e., neither of the DRX-adjustable configurations meets the performance information of the XR device), Operation S816 is proceeded, in which the XR device transmits a C-DRX configuration sequence changing request message to the base station.

In Operation S818, after receiving the C-DRX configuration sequence changing request message transmitted by the XR device, the base station determines whether to accept to change the C-DRX configuration sequence allocated for the XR device. If “yes”, Operation S820 is performed, in which the base station allocates one of the C-DRX configuration sequences selected by the XR device for the XR device according to the C-DRX configuration sequence changing request message, and transmits a new C-DRX configuration message (corresponding to the selected C-DRX configuration sequence) to the XR device. The C-DRX configuration sequences selected by the XR device in Operation S820 are not the same as the C-DRX configuration sequences allocated in Operation S802. On the contrary, if the determination of the base station is “no”, Operation S822 is performed, in which the base station retransmits the same C-DRX configuration message to the XR device for indicating the XR device to select one of the C-DRX configuration sequences allocated previously for XR packet receptions. The C-DRX configuration sequences corresponding to the retransmitted C-DRX configuration message are those allocated in Operation S802.

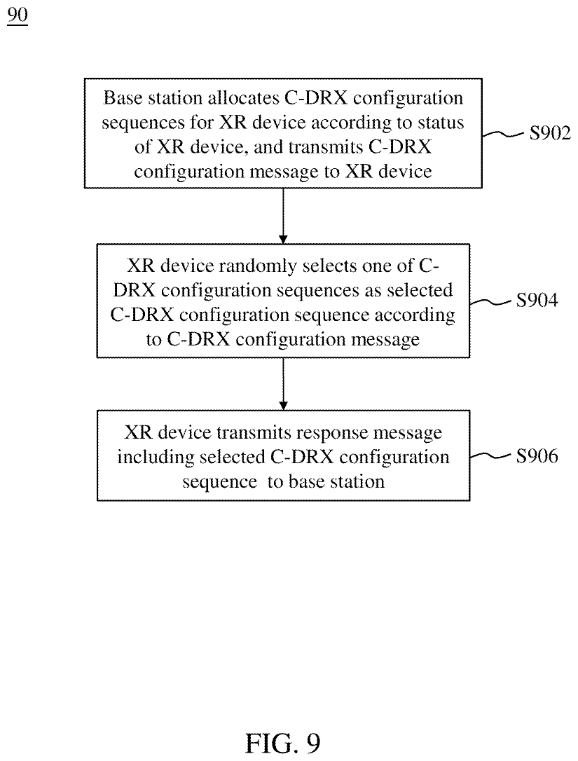

FIG. 9 is a flowchart of a DRX configuration allocating method 90 in accordance with some embodiments of the present disclosure. The DRX configuration allocating method 90 may also be applicable for the wireless communication system 100 in FIG. 1, in which some operations are performed at the base station 122, while the other operations are performed at any UE 110 (i.e., an XR device).

In Operation S902, the base station allocates C-DRX configuration sequences for the XR device according to the status of the XR device (e.g., the remaining battery capacity of the XR device and/or the channel environment of the XR device) and an XR frame rate mode, and transmits a C-DRX configuration message to the XR device. The C-DRX configuration message corresponds to the XR frame rate mode and corresponds to (e.g., includes) the C-DRX configuration sequences.

Taking 90 fps as an example, if the remaining battery capacity of the XR device is sufficient (e.g., the remaining battery capacity is greater than 30%), the base station allocates the C-DRX configuration sequences with lower unnecessary delays and higher unnecessary power consumptions (corresponding to the DRX-adjustable configurations of 8/9, 7/9, and 6/9) for the XR device; if the remaining battery capacity of the XR device is insufficient (e.g., the remaining battery capacity is lower than 30%), the base station allocates the C-DRX configuration sequences with high unnecessary delays and lower unnecessary power consumptions (corresponding to the DRX-adjustable configurations of 0, 1/9, and 2/9) for the XR device.

In Operation S904, the XR device selects (e.g., randomly selects) one of the C-DRX configuration sequences as a selected C-DRX configuration sequence for XR packet receptions according to the C-DRX configuration message.

In Operation S906, the XR device transmits a response message corresponding to (e.g., including) the selected C-DRX configuration sequence to the base station for notifying the base station that a C-DRX configuration sequence is selected for XR packet receptions.

The difference between the DRX configuration allocating method 80 and 90 is, in the DRX configuration allocating method 80, the XR device actively selects a C-DRX configuration sequence for XR packet receptions according to the performance information thereof, while in the DRX configuration allocating method 90, the base station actively allocates C-DRX configuration sequences according to the performance information of the XR device, and the XR device randomly select one of the C-DRX configuration sequences for XR packet receptions.

Summarizing the above, the methods of allocating DRX configuration in the present disclosure can dynamically adjust the C-DRX configuration of an XR device according to the performance information of the XR device to consider both power consumption and delay, thereby optimizing XR packet receptions.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. An extended reality (XR) device, comprising:
a transceiver configured to perform wireless signal transmissions and receptions; and
a processor coupled to the transceiver and configured to perform the following operations:
receiving a first connected-mode discontinuous reception (C-DRX) configuration message from a base station via the transceiver, wherein the first C-DRX configuration message corresponds to an XR frame rate mode and corresponds to a plurality of first C-DRX configuration sequences, wherein the XR frame rate mode is in a unit of millisecond, and wherein the XR frame rate mode is a non-integer frame rate mode; and
selecting one of the plurality of first C-DRX configuration sequences as a selected C-DRX configuration sequence of the XR device according to performance information of the XR device.

2. The XR device of claim 1, wherein a frames per second (FPS) corresponding to the XR frame rate mode comprises one of 15, 30, 45, 60, 72, 90, and 120.

3. The XR device of claim 1, wherein the plurality of first C-DRX configuration sequences comprise at least one non-decreasing sequence and at least one non-increasing sequence.

4. The XR device of claim 1, wherein each of the plurality of first C-DRX configuration sequences comprises two different discontinuous reception (DRX) configurations.

5. The XR device of claim 1, wherein the number of DRX configurations of each of the plurality of first C-DRX configuration sequences is a minimal positive integer that multiplies the XR frame rate mode to become an integer.

6. The XR device of claim 1, wherein the performance information comprises at least one of an amount of power consumption and an amount of delay.

7. The XR device of claim 1, wherein the processor is configured to further perform the following operation:
transmitting a response message to the base station via the transceiver, wherein the response message corresponds to the selected C-DRX configuration sequence.

8. The XR device of claim 1, wherein the processor is configured to further perform the following operations:
acquiring the plurality of first C-DRX configuration sequences neither meeting the performance information;
selecting a plurality of second C-DRX configuration sequences according to the performance information, wherein the plurality of second C-DRX configuration sequences are not the same as the plurality of first C-DRX configuration sequences;
transmitting a C-DRX configuration sequence changing request message to the base station via the transceiver, and receiving a second C-DRX configuration message from the base station via the transceiver, wherein the second C-DRX configuration message corresponds to the XR frame rate mode and corresponds to one of the plurality of second C-DRX configuration sequences; and
selecting the one of the plurality of second C-DRX configuration sequences as the selected C-DRX configuration sequence of the XR device according to the performance information.

9. The XR device of claim 1, wherein the processor is configured to further perform the following operations:
acquiring the plurality of first C-DRX configuration sequences neither meeting the performance information; and
transmitting a C-DRX configuration sequence changing request message to the base station via the transceiver, and receiving a second C-DRX configuration message from the transceiver, wherein the second C-DRX configuration message corresponds to the XR frame rate mode and corresponds to the plurality of first C-DRX configuration sequences.

10. A base station, comprising:
a transceiver configured to perform wireless signal transmissions and receptions; and
a processor coupled to the transceiver and configured to perform the following operations:
allocating a plurality of first C-DRX configuration sequences for an XR device according to an XR frame rate mode, wherein the XR frame rate mode is in a unit of millisecond, and wherein the XR frame rate mode is a non-integer frame rate mode; and
transmitting a first C-DRX configuration message to the XR device via the transceiver, wherein the first C-DRX configuration message corresponds to the XR frame rate mode and corresponds to the plurality of first C-DRX configuration sequences.

11. The base station of claim 10, wherein an FPS corresponding to the XR frame rate mode comprises one of 15, 30, 45, 60, 72, 90, and 120.

12. The base station of claim 10, wherein the plurality of first C-DRX configuration sequences comprise at least one non-decreasing sequence and at least one non-increasing sequence.

13. The base station of claim 10, wherein each of plurality of first C-DRX configuration sequences comprises two different DRX configurations.

14. The base station of claim 10, wherein the number of DRX configurations of each of the plurality of first C-DRX configuration sequences is a minimal positive integer that multiplies the XR frame rate mode to become an integer.

15. The base station of claim 10, wherein the processor is configured to further perform the following operation:
after transmitting the first C-DRX configuration message, receiving a response message from the XR device via the transceiver, wherein the response message corresponds to a selected C-DRX configuration sequence adopted by the XR device from the plurality of first C-DRX configuration sequences.

16. The base station of claim 10, wherein the processor is configured to further perform the following operations:
after transmitting the first C-DRX configuration message, receiving a C-DRX configuration sequence changing request message from the XR device via the transceiver;
allocating one of a plurality of second C-DRX configuration sequences for the XR device according to the C-DRX configuration sequence changing request message, wherein the plurality of second C-DRX configuration sequences are selected by the XR device and are not the same as the plurality of first C-DRX configuration sequences; and
transmitting a second C-DRX configuration message to the XR device via the transceiver, wherein the second C-DRX configuration message corresponds to the XR frame rate mode and corresponds to the one of the plurality of second C-DRX configuration sequences.

17. The base station of claim 10, wherein the processor is configured to further perform the following operations:
after transmitting the first C-DRX configuration message, receiving a C-DRX configuration sequence changing request message from the XR device via the transceiver; and
transmitting a second C-DRX configuration message to the XR device via the transceiver, wherein the second C-DRX configuration message corresponds to the plurality of first C-DRX configuration sequences.

18. A DRX configuration allocating method for an XR device, comprising:
receiving a C-DRX configuration message from a base station, wherein the C-DRX configuration message corresponds to an XR frame rate mode and corresponds to a plurality of C-DRX configuration sequences, wherein the XR frame rate mode is in a unit of millisecond, and wherein the XR frame rate mode is a non-integer frame rate mode; and
selecting one of the plurality of C-DRX configuration sequences as a selected C-DRX configuration sequence of the XR device according to performance information of the XR device.

19. The method of claim 18, wherein an FPS corresponding to the XR frame rate mode comprises one of 15, 30, 45, 60, 72, 90, and 120.

20. The method of claim 18, further comprising:
transmitting a response message to the base station in response to the C-DRX configuration message.
